(19) United States
(12) Patent Application Publication
(10) Pub. No.: US 2023/0070696 A1
(43) Pub. Date: Mar. 9, 2023

(54) HEAT EXCHANGER HAVING A PURIFICATION DEVICE FOR A MOTOR VEHICLE

(71) Applicant: VALEO SYSTEMES THERMIQUES, La Verriere (FR)

(72) Inventors: Christophe DENOUAL, La Verriere (FR); Bastien JOVET, La Verriere (FR); Quentin NAVARRE, La Verriere (FR); Julien VERON, La Verriere (FR)

(73) Assignee: VALEO SYSTEMES THERMIQUES, La Verriere (FR)

(21) Appl. No.: 17/799,296

(22) PCT Filed: Feb. 11, 2021
(86) PCT No.: PCT/FR2021/050254

§ 371 Date: Aug. 12, 2022

(30) Foreign Application Priority Data
Feb. 12, 2020 (FR) FR2001394

(51) Int. Cl. F28F 19/01; F28F 19/00; F28D 9/00

(52) U.S. Cl. CPC F28F 19/01; F28F 19/002; F28D 9/005; F28D 2021/0028

(57) ABSTRACT

The present invention relates to a heat exchanger for a motor vehicle, including a plurality of plates, the plates being stacked on top of one another along a stacking axis so as to form a bundle of plates, at least a first plate and at least a second plate which define a first circulation path configured for circulation of a first fluid, at least the second plate and at least a third plate which define a second circulation path configured for circulation of a second fluid, the bundle of plates having a first distribution chamber which supplies the first circulation path with first fluid, and a second distribution chamber which supplies the second circulation path with second fluid. The heat exchanger includes at least one purification device arranged in one of the distribution chambers.

### CROSS-REFERENCE TO RELATED APPLICATIONS

This application is filed under 35 U.S.C. § 371 U.S. National Phase of International Application No. PCT/FR2021/050254 filed Feb. 11, 2021 (published as WO2021160971), which claims priority benefit to French Application No. 2001394 filed on Feb. 12, 2020, the disclosures of which are herein incorporated by reference in their entirety.

### TECHNICAL FIELD

The present invention relates to the field of heat exchangers, in particular those intended to equip air-conditioning systems and/or cooling systems of motor vehicles. More particularly, the invention relates to systems for cooling electrical storage devices of motor vehicles.

### BACKGROUND OF THE INVENTION

In the automotive sector, it is common to modify a temperature of a component such as an electric motor, a battery, a device for storing heat and/or cold energy, or the like. To this end, the motor vehicle is equipped with an installation that comprises a refrigerant circuit within which a refrigerant circulates, and a heat-transfer liquid circuit within which a heat-transfer liquid circulates. The refrigerant circuit comprises a compressor for compressing the refrigerant, a condenser for cooling the refrigerant at a constant pressure, an expansion member for allowing expansion of the refrigerant, and a heat exchanger that is designed to allow a transfer of heat between the refrigerant and the heat-transfer liquid. The heat-transfer liquid circuit comprises a pump and a heat exchange member that is able to modify a temperature of the component.

One solution, which is currently preferred by a number of manufacturers for cooling the battery cells consists in completely immersing these cells in the heat-transfer fluid. The advantage of such a solution is that it places the heating element in direct contact with the heat-transfer fluid, making it possible to discharge more of the heat released by the cells. Thus, the cooling efficiency is increased compared with the traditional solutions. Moreover, this solution is suitable for all the battery charging modes that are used: rapid, normal or intermediate. Therefore, the efficiency of thermal management is much improved.

A first drawback of such a solution is that the liquid needs to remain free of particles circulating in the fluid in order to avoid premature deterioration of the cells and of the heat exchanger and/or of the pump by abrasion, for example.

A second drawback of such a solution is the risk of a short circuit. Specifically, it is necessary to closely monitor the electrical resistance of the heat-transfer fluid since, if it is contaminated with conductive elements that are for example present in the circuit or introduced by external water, it may become sufficiently electrically conductive to bring about short circuits within the battery.

A third drawback of this solution is the possible corrosion of the cells if the heat-transfer fluid is contaminated with water. Specifically, the temperature of the water in contact with the cells increases, having the consequence of very significantly increasing its corrosive power.

The object of the present invention is to at least partially resolve the above problems and to also lead to other advantages by proposing a new type of heat exchanger for a motor vehicle.

### BRIEF SUMMARY OF THE INVENTION

The invention provides a heat exchanger, in particular for a motor vehicle, comprising a plurality of plates, the plates being stacked one on top of another in a stacking direction to form a bundle of plates, at least one first plate and at least one second plate which define a first circulation path configured for circulation of a first fluid, at least the second plate and at least one third plate which define a second circulation path configured for circulation of a second fluid, the bundle of plates having a first distribution chamber which supplies the first circulation path with first fluid, and a second distribution chamber which supplies the second circulation path with second fluid. The heat exchanger also comprises at least one purification device arranged in one of the distribution chambers.

Thus, a function of the purification device may be to retain the particles that have a diameter large enough to block and/or deteriorate a circulation path by abrasion.

In the context of cooling of cells of a battery, the purification device may furthermore have a function of absorbing any conductive particles coming from other components or from an external environment, which therefore represent a risk of a short circuit.

The purification device may make it possible to withdraw the water that has been introduced into the heat exchanger and thus to prevent the corrosion of and/or conduction of electricity thereby.

Lastly, the pressure drops brought about by the use of the purification device entail the advantage of the first fluid or the second fluid being better distributed in the plates of the bundle of the heat exchanger. In other words, the pressure drops created by the purification device are used to distribute the flow rate more uniformly in each of the plates.

According to one embodiment, the purification device has a shape substantially complementary to a shape of the distribution chamber in which it is arranged. Here, and throughout the following text, the term “substantially” should be understood as meaning that the production tolerances, and any assembly tolerances, need to be taken into account.

According to one embodiment, the purification device is in the form of a cylinder. More particularly, the purification device is in the form of a straight cylinder with a circular or triangular base.

According to one embodiment, the purification device extends along the entire length of the distribution chamber accommodating it, as measured along the stacking axis.

According to one embodiment, the distribution chamber accommodating the purification device passes through the bundle along the stacking axis.

According to one embodiment, the purification device comprises a perforated support defining a perimeter of the purification device and a compartment of the purification device.

According to one embodiment, the purification device comprises at least one filter and/or at least one desiccant.

A “desiccant” should be understood here, and throughout the following text, as being a water absorbent element or a mixture of one or more water absorbent elements and/or other compounds.

According to one embodiment, the filter comprises a filtering surface, the filtering surface being disposed circumferentially on the support.

According to one embodiment, the filtering surface has a porosity of between 10 μm and 500 μm. The porosity is a maximum dimension of the particles retained by the filtering surface.

According to one embodiment, the desiccant comprises at least one water absorbent element chosen from a silica gel, a magnesium sulfate, a calcium chloride, a calcium sulfate, a lithium chloride, and a molecular sieve, for example a zeolite.

According to one embodiment, the desiccant comprises a pouch arranged in the compartment of the purification device, the water absorbent element being disposed in the pouch.

According to one embodiment, the heat exchanger comprises an interface that is able to cooperate with an orifice of the distribution chamber accommodating the purification device and with the purification device.

The interface makes it possible to connect the circulation path to a loop or a circuit. Thus, the fluid entering the distribution chamber accommodating the purification device through the interface is purified before passing along the circulation path.

According to one embodiment, the passage of the interface and the compartment of the purification device are in hydraulic communication.

According to one embodiment, the interface is in one piece with at least a part of the purification device. Here, and throughout the following text, the term “in one piece” should be understood as meaning that the elements in one piece are integral, in one block.

According to one embodiment, the interface is formed integrally with at least a part of the purification device.

Here, and throughout the following text, the term “formed integrally” should be understood as meaning that the elements that are formed integrally form a single component and are therefore made of the same material or materials. This component can be obtained for example by molding or by injection molding. This component therefore differs from elements that are joined together by welding or bonding.

According to one embodiment, the distribution chamber accommodating the purification device comprises a first and a second end, the first end being open onto an external environment of the bundle along the stacking axis.

According to one embodiment, the heat exchanger comprises a sealing member disposed between the interface and the purification device.

According to one embodiment, the heat exchanger comprises at least one sealing member arranged around one end of the interface.

According to one embodiment, the heat exchanger comprises at least one sealing member arranged around one end of the purification device.

According to one embodiment, the bundle has a mouth at one end, the mouth being configured to admit the fluid and for manipulating the purification device with respect to the heat exchanger. Here, and throughout the following text, the term “manipulate” should be understood as meaning both the extraction of the purification device from and the insertion thereof into a distribution chamber in order to replace it.

According to one embodiment, the mouth is in line with the end of the distribution chamber that is open onto an external environment of the bundle along the stacking axis.

According to one embodiment, the purification device comprises a fluid intake opening. This opening makes it possible to admit the first or the second fluid into the purification device before it passes along one of the circulation paths.

According to one embodiment, the interface comprises a passage configured to be in communication with a fluid intake opening of the purification device.

According to one embodiment, the purification device comprises a locking system for attaching the purification device to the interface and/or to the mouth of the bundle.

According to one embodiment, the locking system is configured to attach the interface to the mouth of the bundle.

According to one embodiment, the locking system comprises a fixing bushing. According to one embodiment, the locking system comprises a connecting bushing.

According to one embodiment, the locking system comprises a spring clip.

According to one embodiment, the second end of the distribution chamber accommodating the purification device is open onto an external environment of the bundle along the stacking axis.

According to one embodiment, the purification device has an end cap at an opposite end from a fluid intake opening.

According to one embodiment, the bundle has a first mouth at a first end and a second mouth at a second end, the first mouth being configured to admit the fluid and the second mouth being configured for manipulating the purification device with respect to the heat exchanger.

According to one embodiment, the first mouth is in line with the first end of the distribution chamber.

According to one embodiment, the second mouth is in line with the second end of the distribution chamber.

According to one embodiment, the purification device comprises a fixing device configured to attach the end cap to the second mouth.

According to one embodiment, the fixing device comprises a spring clip that is able to cooperate with the end cap in order to fix the end cap to the second mouth.

According to one embodiment, the fixing device is a screw thread arranged at a periphery of the end cap and configured to cooperate with a tapped thread in the second mouth.

According to one embodiment, one end of the purification device is accommodated in a passage of the interface.

According to one embodiment, the heat exchanger comprises at least one sealing member arranged around the end cap.

According to one embodiment, the first fluid comprises at least one heat-transfer fluid. In other words, the first fluid may comprise a heat-transfer fluid or a mixture of one or more heat-transfer fluids and one or more other fluids.

According to one embodiment, the heat-transfer fluid comprises at least one dielectric heat-transfer fluid. In other words, the heat-transfer fluid may comprise a dielectric heat-transfer fluid or a mixture of one or more dielectric heat-transfer fluids and one or more other fluids.

According to one embodiment, the dielectric heat-transfer fluid has a dielectric constant greater than or equal to 78 at 25° C.

According to one embodiment, the dielectric heat-transfer fluid comprises at least one compound chosen from a mineral oil, a synthetic oil, a fluorinated ether, a silicone, and a fluorinated hydrocarbon.

According to one embodiment, the fluorinated hydrocarbon is chosen from a perfluorohexane, a perfluoromethylcyclohexane, a perfluoro-1,3-dimethylcyclohexane, a perfluorodecalin, a perfluoromethyldecalin, a trichlorofluoromethane and a trichlorotrifluoroethane.

According to one embodiment, the second fluid comprises at least one refrigerant. In other words, the second fluid may comprise a refrigerant or a mixture of one or more refrigerants and one or more other fluids.

According to one embodiment, the refrigerant is chosen from a hydrochlorofluorocarbon (HCFC), a hydrofluorocarbon (HFC) and a carbon dioxide.

According to one embodiment, the hydrofluorocarbon is chosen from 1,1,1,2-tetrafluoroethane and 2,3,3,3-tetrafluoropropene.

According to one embodiment, the purification device is a first purification device arranged in the first distribution chamber, the bundle of plates comprises a first discharge chamber configured to receive the first fluid that has passed along the first circulation path, and the heat exchanger comprises a second purification device arranged in the first discharge chamber.

According to one embodiment, the purification device is a first purification device arranged in the first distribution chamber and wherein the heat exchanger comprises a second purification device arranged in the second distribution chamber.

According to one embodiment, the second purification device comprises a perforated support defining a perimeter of the second purification device and a compartment of the second purification device.

According to one embodiment, the second purification device comprises at least one filter and/or at least one desiccant.

According to one embodiment, the filter of the second purification device comprises at least one filtering surface, the filtering surface being disposed circumferentially on the support.

According to one embodiment, the filtering surface of the second purification device has a porosity of between 10 μm and 500 μm.

According to one embodiment, the desiccant of the second purification device comprises at least one water absorbent element chosen from a silica gel, a magnesium sulfate, a calcium chloride, a calcium sulfate, a lithium chloride, and a molecular sieve, for example a zeolite.

According to one embodiment, the desiccant of the second purification device comprises a pouch arranged in the compartment of the second purification device, the water absorbent element being disposed in the pouch.

According to one embodiment, the invention also provides a system for cooling an electrical storage device for motor vehicles. The system comprises a heat exchanger according to the invention, a loop thermally coupled to the electrical storage device and in communication with the first circulation path of the exchanger, and a circuit in communication with the second circulation path of the heat exchanger.

According to one embodiment, the loop is passed through by a dielectric heat-transfer fluid and the circuit is passed through by a refrigerant.

According to one embodiment, the invention provides a vehicle comprising a heat exchanger according to the invention and/or a cooling system according to the invention.

According to one embodiment, the invention provides a method for replacing a used purification device. The replacement method comprises a step of emptying an exchanger according to one of the preceding claims, a step of extracting the used purification device from the distribution chamber and a step of introducing a replacement purification device into the distribution chamber.

### BRIEF DESCRIPTION OF THE DRAWINGS

Further features and advantages of the invention will become more apparent both from the following description and from a plurality of non-limiting exemplary embodiments that are given by way of indication with reference to the attached schematic drawings, in which:

FIG. 1 is a schematic perspective view of a heat exchanger comprising a purification device according to a first embodiment of the invention as seen from a first viewing angle;

FIG. 2 is a schematic perspective view of a plate of a bundle of the heat exchanger in FIG. 1;

FIG. 3 is a schematic view of the bundle plates of the heat exchanger in FIG. 1;

FIG. 4 is a truncated cross-sectional view on a plane parallel to the plane YZ of a heat exchanger that is able to house a purification device according to the first embodiment;

FIG. 5 is a truncated cross-sectional view at a viewing angle of a heat exchanger that is able to house a purification device according to a second embodiment;

FIG. 6 is a truncated cross-sectional view on a plane parallel to the plane YZ of a heat exchanger comprising a purification device according to a third embodiment;

FIG. 7 is a truncated cross-sectional view on a plane parallel to the plane YZ of a heat exchanger comprising a purification device according to a fourth embodiment;

FIG. 8 is a perspective cross-sectional view at a viewing angle of a heat exchanger comprising a purification device according to a fifth embodiment;

FIG. 9 is a truncated cross-sectional view on a plane parallel to the plane YZ of a heat exchanger comprising a purification device according to a sixth embodiment; and

FIG. 10 is a truncated cross-sectional view on a plane parallel to the plane YZ of a heat exchanger comprising a purification device according to a seventh embodiment.

### DETAILED DESCRIPTION OF THE INVENTION

It should first of all be noted that, although the figures set out the invention in detail for its implementation, they may of course be used to better define the invention if necessary. It should also be noted that, in all of the figures, elements that are similar and/or perform the same function are indicated using the same numbering.

In the following description, a direction of a longitudinal axis X, a direction of a transverse axis Y, and a direction of a vertical axis Z are represented by a trihedron (X, Y, Z) in the figures. A horizontal plane is defined as being a plane perpendicular to the vertical axis, a longitudinal plane is defined as being a plane perpendicular to the transverse axis, and a transverse plane is defined as being a plane perpendicular to the longitudinal axis.

The heat exchanger 1 according to the invention may be used in a cooling system, in particular for cooling cells of an electric battery. The cooling system comprises a heat exchanger 1 according to the invention, a loop thermally coupled to the electrical storage device and in communication with the first circulation path 6 (represented by the arrows 6) of the heat exchanger 1, and a circuit in communication with the second circulation path 7 (represented by the arrows 7) of the heat exchanger 1.

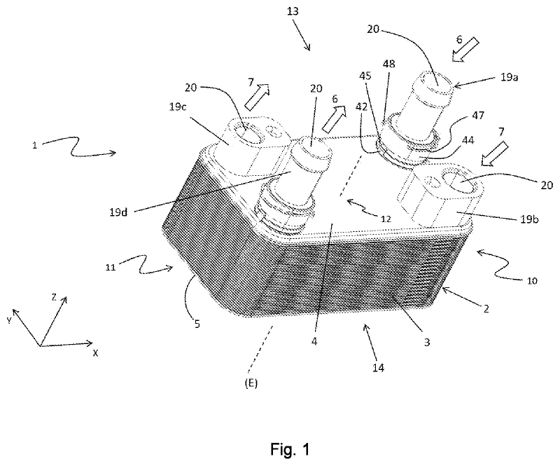

FIG. 1 shows a perspective view of a heat exchanger 1 according to the invention, which is used in particular to cool cells of an electric battery. This heat exchanger 1 could also be employed to cool and/or heat other components located in a motor vehicle.

The heat exchanger 1 implements an exchange of heat energy between a first fluid and a second fluid, the first fluid then being cooled by the second fluid. The first fluid is advantageously a heat-transfer fluid or a mixture of one or more heat-transfer fluids and one or more other fluids, the heat-transfer fluid or fluids being selected from the heat-transfer fluids that are allowed and suitable for the use made thereof. The heat-transfer fluid or fluids are in particular dielectric heat-transfer fluids. A dielectric heat-transfer fluid is a heat-transfer fluid that is free of electric charges that are liable to move macroscopically. The dielectric heat-transfer fluid therefore cannot conduct the electric current. In other words, a breakdown voltage of the dielectric heat-transfer fluid is high enough to avoid any conduction of electric current through the electric battery.

Such dielectric heat-transfer fluids may be in the form of dielectric liquids. The dielectric heat-transfer fluids may be for example a mineral oil, a synthetic oil, a fluorinated ether, a silicone or a fluorinated hydrocarbon. A fluorinated hydrocarbon is preferably chosen from perfluorohexane, perfluoromethylcyclohexane, perfluoro-1,3-dimethylcyclohexane, perfluorodecalin, perfluoromethyldecalin, trichlorofluoromethane and trichlorotrifluoroethane.

When the heat-transfer liquid is in direct contact with the electric battery cells, preference will be given to liquids that have a dielectric constant greater than or equal to 78 at 25° C.

The second fluid is preferably a refrigerant or a mixture of one or more refrigerants and one or more other fluids, the refrigerant or refrigerants being selected from the refrigerants that are allowed and suitable for the use made thereof The refrigerant or refrigerants are in particular refrigerant liquids from the family of the hydrochlorofluorocarbons (HCFCs) or of the hydrofluorocarbons. The refrigerant liquid may in particular be R134a, known under the name 1,1,1,2-tetrafluoroethane, or 1234YF, also known as 2,3,3,3-tetrafluoropropene. The refrigerant liquid may also be carbon dioxide known under the reference R744.

With reference to FIG. 1, the heat exchanger 1 comprises a bundle 2 formed by a stack of plates 3, which are superposed one on top of another along a stacking axis E, parallel to the vertical axis Z. The heat exchanger 1, and therefore the bundle 2, comprises a first longitudinal end 10 and a second longitudinal end 11 at the opposite end from the first longitudinal end 10 along the longitudinal axis X. The first longitudinal end 10 and the second longitudinal end 11 are at opposite ends with respect to a center 12 of the heat exchanger 1.

The heat exchanger 1, and therefore the bundle 2, comprises a first transverse end 13 and a second transverse end 14 at the opposite end from the first transverse end 13 along the transverse axis Y. The first transverse end 13 and the second transverse end 14 are at opposite ends with respect to the center 12 of the heat exchanger 1.

The bundle 2 comprises an upper end plate 4 and a lower end plate 5, which delimit the bundle 2 along the stacking axis E. Arranged between these two end plates 4, 5 are the plates 3, which delimit two separate circulation paths: a first circulation path 6 configured to be passed along by the first fluid and a second circulation path 7 configured to be passed along by the second fluid.

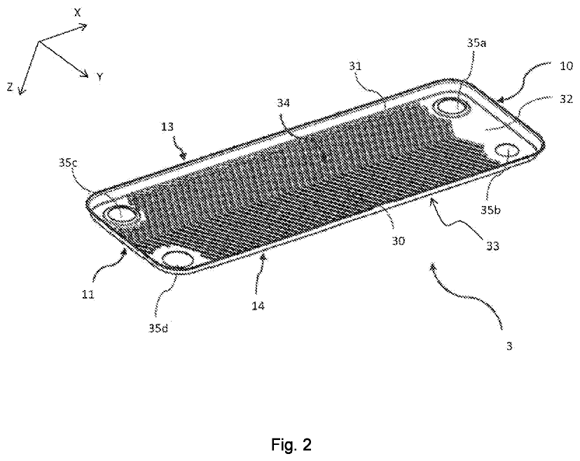

An example of a plate 3 is illustrated in FIG. 2. Two immediately adjacent plates 3 define a circulation tube in which the first fluid or the second fluid can circulate. The circulation tubes designed for the circulation of the first fluid, known as first circulation tubes, alternate with the tubes designed for the circulation of the second fluid, known as second circulation tubes. Thus, a first plate 3 can be designed for the circulation of the first fluid in cooperation with an adjacent second plate 3, and be designed for the circulation of the second fluid in cooperation with an adjacent third plate 3. One and the same plate 3 is thus skimmed over on one side by the first fluid and on the other by the second fluid.

The set of first circulation tubes forms the first circulation path 6. The set of second circulation tubes forms the second circulation path 7.

As can be seen in FIG. 2, each plate 3 is in the form of a trough, meaning that it comprises a bottom 30 surrounded by a peripheral edge 31. The bottom 30 is in the form of a rectangle with rounded corners. The peripheral edge 31 surrounding the bottom extends continuously all around the plate 3.

The plates 3 are stacked one on top of another, an upper face 32 of a first plate 3 being located next to a lower face 33 of an adjacent second plate 3. In the same way, a lower face 33 of the first plate 3 is located next to an upper face 32 of an adjacent third plate 3.

The plates 3 are manufactured by pressing, stamping or rolling a strip of a material designed to allow sufficient exchanges of heat to allow the heat exchanger 1 to fulfill its role. The material may in particular be aluminum or an aluminum alloy.

The plates 3 comprise at least one disrupting device 34, illustrated in FIG. 2 and designed to disrupt the circulation of the fluid or fluids circulating along the plates 3. This makes it possible to improve the exchanges of heat between the first fluid and the second fluid. The disrupting device 34 is for example formed in one piece with the plates 3, meaning that they form a single block of material with the plate 3 in which they are formed. The disrupting device 34 may therefore be produced by the method for manufacturing the plate 3, and is for example pressed at the same time as the plate 3.

The disrupting device 34 extends over the upper face 32 and over the lower face 33 of the bottom 30 along the vertical axis Z and extends between the first longitudinal end 10 and the second longitudinal end 11 of the plate 3. In the example illustrated in FIG. 2, the disrupting device 34 takes the form of chevrons, that is to say a succession of furrows with V-shaped profiles as seen in a plane perpendicular to the vertical axis Z, that is to say in the horizontal plane.

Each plate 3 also comprises holes 35a, 35b, 35c, 35d. In the example of the invention, the plates 3 each have four holes, which are each disposed at the corners of the plate 3 and arranged in the bottom 30. The plates thus have a first hole 35a, a second hole 35b, a third hole 35c and a fourth hole 35d. The holes 35a, 35b, 35c, 35d have a circular shape. The holes 35a, 35b, 35c, 35d are through-holes. These holes 35a, 35b, 35c, 35d are designed to allow the passage of the first fluid or of the second fluid.

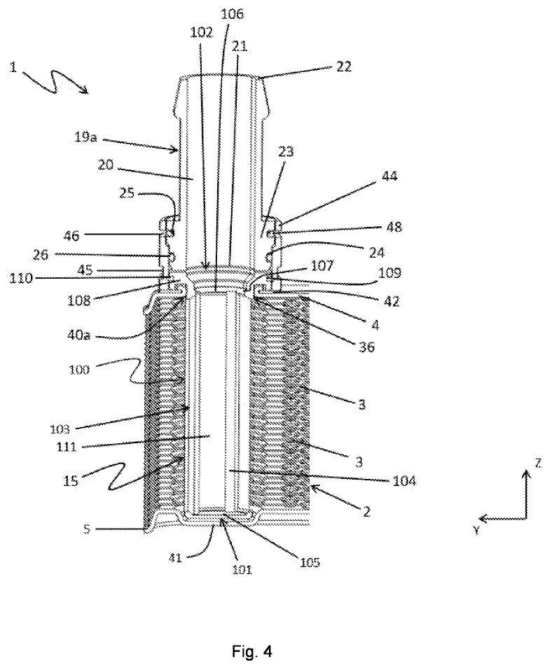

With reference to FIGS. 2 to 4, the first hole 35a is disposed at the corner of the first longitudinal end 10 and of the first transverse end 13. When the plates 3 are stacked and form the bundle 2, the first holes 35a are then aligned with one another and form a first distribution chamber 15 for distributing the first fluid in the first circulation path 6. The first distribution chamber 15 is bordered by the contour of the first holes 35a, the lower end plate 5 and the upper end plate 4. It is therefore in the form of a straight cylinder with a circular base. The first distribution chamber 15 makes it possible to distribute the first fluid in the first circulation tubes. The first distribution chamber 15 houses a purification device 100, as can be seen in FIG. 4. The first circulation tubes form the first circulation path 6.

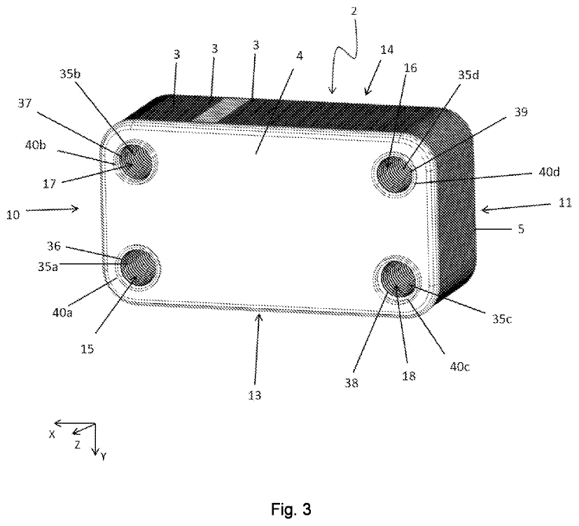

As illustrated in FIGS. 2 and 3, the second hole 35b is disposed at the corner of the first longitudinal end 10 and the second transverse end 14. When the plates 3 are stacked and form the bundle 2, the second holes 35b are then aligned with one another and form the second distribution chamber 17 for distributing the second fluid on the second circulation path 7. The second distribution chamber 17 is bordered by the contour of the second holes 35b, the lower end plate 5 and the upper end plate 4. It is therefore in the form of a straight cylinder with a circular base. The second distribution chamber 17 makes it possible to distribute the second fluid in the second circulation tubes forming the second circulation path 7.

With reference to FIGS. 2 and 3, the third hole 35c is disposed at the corner of the second longitudinal end 11 and the first transverse end 13. When the plates 3 are stacked and form the bundle 2, the third holes 35c are then aligned with one another and form a second discharge chamber 18 for discharging the second fluid in the second circulation path 7. The second discharge chamber 18 is bordered by the contour of the third holes 35c, the lower end plate 5 and the upper end plate 4. It is therefore in the form of a straight cylinder with a circular base. The second discharge chamber 18 makes it possible to collect the second fluid distributed in the second circulation tubes and send it toward the circuit in communication with a second circulation path 7.

As shown in FIGS. 2 and 3, the fourth hole 35d is disposed at the corner of the second longitudinal end 11 and the second transverse end 14. When the plates 3 are stacked and form the bundle 2, the fourth holes 35d are then aligned with one another and form a first discharge chamber 16 for discharging the first fluid. The first discharge chamber 16 is bordered by the contour of the fourth holes 35d, the lower end plate 5 and the upper end plate 4. It is therefore in the form of a straight cylinder with a circular base. The first discharge chamber 16 makes it possible to collect the first fluid distributed in the first circulation tubes and send it toward the loop thermally coupled to the electrical storage device.

To obtain the bundle 2 of plates 3, the different plates 3 are stacked in the stacking direction E. The set of plates 3 are then brazed in a brazing process by passing through a furnace. This step secures the different plates 3 together.

As illustrated in FIGS. 2 to 4, the bundle 2 comprises upper mouths 40a, 40b, 40c, 40d for allowing the distribution chambers 15, 17 and the discharge chambers 16, 18 to be open onto the exterior of the bundle 2. In the example of the invention, the bundle 2 has four upper mouths 40a, 40b, 40c, 40d formed at the upper end plate 4 and disposed in line with the holes 35a, 35b, 35c, 35d in the plates 3. The upper end plate 4 thus has a first upper mouth 40a disposed in line with the holes 35a, a second upper mouth 40b disposed in line with the holes 35b, a third upper mouth 40c disposed in line with the holes 35c, and a fourth upper mouth 40d disposed in line with the holes 35d. The upper mouths 40a, 40b, 40c, 40d have a substantially circular shape in the horizontal plane. The upper mouths 40a, 40b, 40c, 40d are through-mouths.

The first upper mouth 40a delimits a first upper orifice 36 of the first distribution chamber 15. The second upper mouth 40b delimits a second upper orifice 37 of the second distribution chamber 17. The third upper mouth 40c delimits a second upper breach 38 of the second discharge chamber 18. The fourth upper mouth 40d delimits a first upper breach 39 of the first discharge chamber 16.

The heat exchanger 1 also comprises interfaces 19a, 19b, 19c, 19d for placing these circulation paths in communication with exterior circulation paths. Thus, some of the interfaces 19a, 19b, 19c, 19d place the loop thermally coupled to the electrical storage device into communication with the first circulation path 6 of the heat exchanger 1. Others of the interfaces 19a, 19b, 19c, 19d make it possible to connect the second circulation path 7 of the heat exchanger 1 to the circuit.

In the example of the invention according to a first embodiment illustrated in FIGS. 1 to 4, the heat exchanger 1 comprises a first interface 19a in order for the first fluid exiting the loop to be able to enter the heat exchanger 1 through the first upper orifice 36 of the first distribution chamber 15.

The heat exchanger 1 also has a second interface 19b in order for the second fluid exiting the circuit to be able to enter the heat exchanger 1 through the second upper orifice 37 of the second distribution chamber 17.

The heat exchanger 1 furthermore has a third interface 19c through which the second fluid can leave the heat exchanger 1 through the second upper breach 38 of the second discharge chamber 18 and pass into the circuit.

The heat exchanger 1 furthermore comprises a fourth interface 19d through which the first fluid can leave the heat exchanger 1 through the first upper breach 39 of the first discharge chamber 16 and pass into the loop.

In the first embodiment illustrated in FIG. 4, the first interface 19a is in the form of a sleeve. The first interface 19a comprises a lower base 21 and an upper base 22 on the opposite side from the lower base 21. These bases 21, 22 are disposed along the vertical axis Z. The lower base 21 is closer to the first upper mouth 40a than the lower base 21. The lower base 21 is connected to the upper base 22 by a passage 20. Thus, it is possible for the first fluid to circulate from the loop into the first distribution chamber 15. The passage 20 is therefore in line with the first upper orifice 36 of the first distribution chamber 15. The first interface 19a extends from the first upper mouth 40a of the upper end plate 4 away from the bundle 2 along the vertical direction Z. The passage 20 extends perpendicularly with respect to the horizontal plane as defined above. The first upper mouth 40a is therefore an opening for admitting the first fluid into the first distribution chamber 15 of the bundle 2 of the heat exchanger 1.

The first interface 19a furthermore comprises a flange 23 at the lower base 21, configured to cooperate with the purification device 100. The flange 23 extends from the lower base 21 radially with respect to the vertical axis Z. The flange 23 is flush with a contour of the lower base. The first interface 19a and the flange 23 are made in one piece. Furthermore, the first interface 19a comprises a first slot 24 in the vicinity of the flange 23. The first slot 24 is arranged circumferentially on the outside of the first interface 19a. The first slot 24 houses a first O-ring 26, which is a sealing member. The first O-ring 26 may comprise an elastomer. The first interface 19a comprises a second slot 25 in the vicinity of the first slot 24. The second slot 25 is arranged circumferentially on the outside of the first interface 19a. The second slot 25 houses a spring clip 48. The first slot 24 is disposed between the flange 23 and the second slot 25 along the vertical axis Z.

The second interface 19b is in the form of a cylinder with a square base. This second interface 19b is provided with a passage 20 designed to allow the second fluid to be transferred from the circuit into the second distribution chamber 17. The passage 20 is therefore in line with the second upper orifice 37 of the second distribution chamber 17. The second interface 19b with a square base extends from the second mouth 40b of the upper end plate 4 away from the bundle 2 along the vertical direction Z. Two adjacent corners of the second interface 19b with a square base are rounded.

The third interface 19c is in the form of a cylinder with a square base. This third interface 19c is provided with a passage 20 designed to allow the second fluid to be transferred from the second discharge chamber 18 toward the circuit. The passage is therefore in line with the second upper breach 38 of the second discharge chamber 18. The third interface 19c with a square base extends from the third mouth 40c of the upper end plate 4, away from the bundle 2 along the vertical direction Z. Two adjacent corners of the third interface 19c with a square base are rounded.

The fourth interface 19d is in the form of a sleeve. The sleeve has a circular base in the example in FIG. 1. The sleeve is provided with a passage 20 at its center to allow the first fluid to be transferred from the first discharge chamber 16 toward the loop thermally coupled to the electrical storage device. The fourth interface 19d extends from the vicinity of the fourth upper mouth 40d of the upper end place away from the bundle 2 along the vertical direction Z. The passage 20 is therefore in line with the first upper breach 37 of the first discharge chamber 16.

In the first embodiment illustrated in FIG. 4, the lower end plate 5 comprises an indentation 41. This indentation 41 is arranged on a face of the end plate 5 that is oriented toward the plates 3. It has a circular bottom, the walls of which are slightly flared. The indentation 41 is arranged in line with the alignment of the first holes 35a so as to form a bottom of the first distribution chamber 15. The indentation 41 is intended to house a part of the purification device 100.

As illustrated in FIG. 4, the heat exchanger 1 comprises a purification device 100 disposed in the first distribution chamber 15. At least a part of the purification device 100 comprises a shape substantially complementary to a shape of the first distribution chamber 15 in which it is partially arranged. Since the first distribution chamber 15 is a straight cylinder with a circular base, the purification device 100 therefore has a part in the form of a straight cylinder with a circular base. The purification device 100 extends along a direction of extension substantially parallel to the vertical axis Z. The purification device 100 has a first vertical end 101 and a second vertical end 102 at the opposite end from the first vertical end 101 along the vertical axis Z.

The purification device 100 comprises a container 103 having a lateral wall 104. The lateral wall 104 has a shape with a circular section and is symmetric overall about the vertical axis Z. Moreover, the lateral wall 104 has three windows. The container 103 delimits the cylindrical perimeter of the purification device 100. The container 103 is closed at the first vertical end 101 by a bottom 105. The lateral wall 104 and the bottom 105 are made in one piece. The bottom 105 rests in the indentation 41 of the lower end plate 5. The container 103 is therefore a perforated support defining a perimeter of the purification device 100 and a compartment of the purification device 100.

The container 103 has an opening 106 at the second vertical end 102. The opening 106 is delimited by an edge 107. In the context of the example illustrated in FIG. 4, the container 103 comprises, at the opening 106, a flange 108 configured to cooperate with the flange 23 of the first interface 19a. The flange 108 has a toric shape as seen in the horizontal plane. The dimensions measured in a horizontal plane of the flange 108 of the purification device 100 correspond to the dimensions measured in a horizontal plane of the toric shape of the flange 23 of the first interface 19a. Thus, the flow of the first fluid from the loop passes into the purification device 100 before entering the first circulation tubes. The flange 108 of the container 103 is formed integrally with the lateral wall 104. The flange 108 is situated outside the bundle 2.

The flange 108 comprises a rail 109 which houses a second O-ring 110, which is also a seal. The second O-ring may comprise for example an elastomer. The rail 109 extends circumferentially around a radial end of the flange 108.

The purification device 100 also comprises a filter. The filter is in the form of filtering surface 111. The filtering surface 111 is disposed circumferentially in the container 103. The filtering surface 111 has a porosity such that the particles which are present in the first fluid and the size of which could damage the heat exchanger 1, for example the plates 3 of the bundle 2, by abrasion cannot pass through the filtering surface 111. The filtering surface 111 has a porosity of between 10 μm and 500 μm. In other words, a maximum dimension of the particles retained by the filtering surface is between 10 μm and 500 μm. The filtering surface 111 is arranged in the container 103 so as to cover the windows. The filtering surface 111 is pressed against the windows. The filtering surface 111 is also arranged in the container 103 such that the majority of the pores are disposed in line with the windows.

A method for manufacturing the purification device 100 involves disposing the filtering surface 111 in a mold and then injecting material to overmold the container 103 on the filtering surface 111. The material may in particular be aluminum or an aluminum alloy.

To eliminate the water mixed with the first fluid, the purification device 100 furthermore comprises a desiccant having at least one water absorbent element chosen from a silica gel, a magnesium sulfate, a calcium chloride, a calcium sulfate, a lithium chloride, and a molecular sieve, for example a zeolite. The desiccant comprises a pouch (not shown) which is permeable to the first fluid and in which the water absorbent element is packaged. This pouch is disposed in the compartment.

In the first embodiment illustrated in FIGS. 1 and 3, the fixation of the purification device 100 in position in the heat exchanger 1 and the fixation of the purification device 100 at the first interface 19a makes use of a fixing bushing 42. The fixing bushing 42 is in the overall shape of a ring. Three fixing tabs extend from an upper contour of the fixing bushing 42 toward the connecting flange 108 of the purification device 100 along the vertical axis Z. A lower contour of the fixing bushing 42, on the opposite side from the upper contour, is brazed to the first upper mouth 40a of the bundle 2.

The fixation of the purification device 100 in position in the heat exchanger 1 and the fixation of the purification device at the first interface 19a also requires a connecting bushing 44. The connecting bushing 44 is in the overall shape of a cylinder with a circular base. The connecting bushing 44 comprises a groove 45 arranged circumferentially on the outer wall of the connecting bushing 44 in order to cooperate with the fixing tabs of the fixing bushing 42. When the fixing tabs of the fixing bushing 42 cooperate with the groove 45, the connecting bushing 44 is crimped to the bundle 2 via the fixing bushing 42.

The connecting bushing 44 also comprises two recesses 46 arranged on a part of the circumference, that is to say on the outer wall of the connecting bushing 44. The two recesses 46 are diametrically opposite one another with respect to the vertical axis Z. These recesses 46 serve to accommodate a spring clip 48, for example a circlip.

The recesses 46 have two pierced holes that open onto the second slot 25 of the first interface 19a. The two pierced holes are diametrically opposite one another. Each pierced hole allows through a part of the spring clip 48, which is accommodated in the second slot 25 of the first interface 19a.

Following the crimping of the connecting bushing 44 to the fixing bushing 42, the purification device 100 is introduced into the first distribution chamber 15 through the first upper opening 36 of the first distribution chamber 15. The bottom 105 of the container 103 then comes into contact with the indentation 41. The flange 108 of the purification device 100 is located outside the first distribution chamber 15 and inside the connecting bushing 44. Next, the first interface 19a is inserted into the connecting bushing 44 such that the flange 23 of the first interface 19a cooperates with the flange 108 of the purification device 100. Then, the spring clip 48 is positioned in the recesses 46, and each pierced hole is then passed through by a part of the spring clip 48 in order to be accommodated in the second slot 25. The spring clip 48 is deformed elastically, thereby holding the first interface 19a and the purification device 100 in position at the connecting bushing 44. The sealing between the bundle 2 and the purification device 100 is ensured by the second O-ring 110 accommodated in the rail 109, the compression of which is brought about by the positioning of the spring clip 48. The sealing between the connecting bushing 44 and the first interface 19a is ensured by the first O-ring 26 accommodated in the first slot 24, the compression of which is brought about by the spring clip 48, which therefore makes it possible to hold the assembly of the purification device 100 and first interface 19a in the heat exchanger 1. In other words, the sealed connection between the bundle 2, the purification device 100 and the first interface 19a is brought about by the compression of the two O-rings by virtue of the spring clip 48.

In this embodiment, the locking system of the purification device 100, which makes it possible to fix the purification device 100 to the bundle 2 of plates 3, comprises the fixing bushing 42, the connecting bushing 44, the rail 109 with the O-ring 110, and the spring clip 48.

In order to change the purification device 100 of the heat exchanger 1 of this first embodiment, it is first of all necessary to remove the spring clip 48. After removing the spring clip 48, the first interface 19a and the purification device 100 are disconnected from the connecting bushing 44 and therefore from the bundle 2 of plates 3. The heat exchanger 1 can then be purged of the first fluid. Next, the purification device 100 can be withdrawn through the first upper orifice 36 of the first distribution chamber 15. Once the purification device 100 has been withdrawn, the first distribution chamber 15 is empty and ready to house another purification device 100.

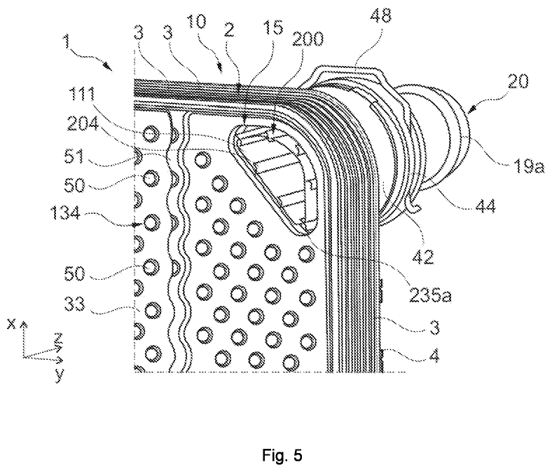

FIG. 5 shows a second embodiment of the purification device 200 according to the invention. This second embodiment shows that it is possible to adapt the shape of the container 103 to the shape of the first distribution chamber 15. The second embodiment illustrated in FIG. 5 is identical to the first embodiment described apart from the holes 35a, 35b, 35c, 35d in the plates 3, the shape of the container 103 of the purification device 100, and the disrupting device 34 of the first embodiment. For the elements that are identical, reference can be made to the description of FIGS. 1 to 4, which are described above.

With reference to FIG. 5, the holes 235a in the plates 3 of the bundle 2 have a substantially triangular shape. The first distribution chamber 15 is then in the form of a straight cylinder with a triangular base. The second distribution chamber 17 and the discharge chambers 15, 16 may also be in the form of a straight cylinder with a triangular base if all the corresponding holes in the plates 3 of the bundle 2 have a substantially triangular shape.

The heat exchanger 1 comprises a purification device 200 configured to cooperate with the first distribution chamber 15. In order for it to be possible to accommodate the purification device 200 in the first distribution chamber 15, the shape of the container 204 of the purification device 200 is then also a straight cylinder with a triangular base. The container 103 is surmounted by a toric flange, as in the first embodiment.

As illustrated in FIG. 5, the disrupting device 134 may have some other shape, such as studs 50 distributed uniformly over the lower face 33. It may also be disposed on the upper face of the plate 3. These studs 50 extend from the lower face along the vertical axis Z. The disrupting device 134 comprises a low wall 51 which extends from the first longitudinal end 10 in the vicinity of the second longitudinal end of the plate 3. It extends from the lower face 33 along the vertical axis Z. Each low wall 51 divides the lower face 33 of the plate 3 into two equal parts.

The assembly and disassembly of the heat exchanger 1 in this second embodiment are identical to the assembly and disassembly of the first embodiment explained above.

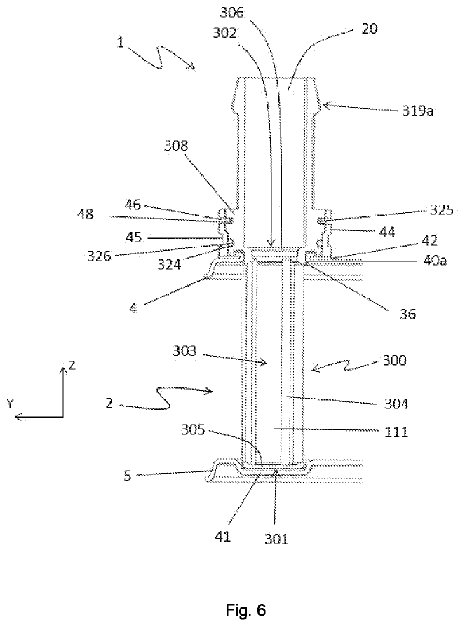

FIG. 6 illustrates a third embodiment of the purification device according the invention. This third embodiment aims to reduce the number of parts to be assembled in order to place the purification device 300 in the heat exchanger 1, by making the purification device 300 and the first interface 319a from an integrally formed part and therefore in one piece. The second embodiment illustrated in FIG. 6 is identical to the first embodiment apart from the purification device and the first interface in the first embodiment. For greater clarity, the plates 3 have been omitted from FIG. 6. For the elements that are identical, reference can be made to the description of FIGS. 1 to 4, which are described above.

As illustrated in FIG. 6, the heat exchanger 1 comprises a purification device 300 disposed in the first distribution chamber 15. At least a part of the purification device 300 comprises a shape substantially complementary to a shape of the first distribution chamber 15 in which it is partially arranged. Since the first distribution chamber 15 is a straight cylinder with a circular base, the purification device 300 therefore has a part in the form of a straight cylinder with a circular base. The purification device 300 extends along a direction of extension substantially parallel to the vertical axis Z. The purification device 300 has a first vertical end 301 and a second vertical end 302 at the opposite end from the first vertical end 301 along the vertical axis Z.

The purification device 300 comprises a container 303 having a lateral wall 304. The lateral wall 304 has a shape with a circular section and is symmetric overall about the vertical axis Z. Moreover, the lateral wall 304 has three windows. The container 303 delimits the cylindrical perimeter of the purification device 300. The container 303 is closed at the first vertical end 301 by a bottom 305. The lateral wall 304 and the bottom 305 are made in one piece. The bottom 305 rests in the indentation 41 of the lower end plate 5. The container 303 is therefore a perforated support defining a perimeter of the purification device 300 and a compartment of the purification device 300.

The container 303 has an opening 306 at the second vertical end 302. In the context of the example illustrated in FIG. 4, the container 303 comprises a flange 308 at the opening 306. The flange 308 extends radially with respect to the vertical axis Z. The flange 308 of the container 303 is formed integrally with the lateral wall 304. The flange 308 is situated outside the bundle 2 of plates 3.

The opening 306 is surmounted by the first interface 319a. The first interface 319a is in the form of a sleeve having a passage 20. Thus, the flow of the first fluid from the loop passes into the purification device 300 before entering the first circulation tubes. The container 303 and the first interface 319a are formed integrally, meaning that they are in one piece, i.e. a single block of material. They are not two separate parts as in the first embodiment.

The system for locking the purification device 300 to the bundle 2 of plates 3 is situated at the flange 308. It comprises a first slot 324 which houses an O-ring 326, which is a sealing member. The O-ring 326 may comprise for example an elastomer. The first slot 324 extends circumferentially around a radial end of the flange 308.

The system for locking the purification device 300 also has a second slot 325 in the vicinity of the first slot 324. The second slot 325 is arranged circumferentially on the outside of the flange 308. The second slot 325 at least partially houses a spring clip 48. The second slot 325 is disposed between the second end 304 and the first slot 325 along the vertical axis Z.

The purification device 300 also comprises a filter in the form of a filtering surface 111 identical to the filtering surface 111 described in the first embodiment.

A method for manufacturing the purification device 300 involves disposing the filtering surface 111 in a mold and then injecting material to overmold the container 303 on the filtering surface 111 and the first interface 319a. The material may in particular be aluminum or an aluminum alloy.

To eliminate the water mixed with the first fluid, the purification device 300 comprises at least one desiccant accommodated in the container 303. The desiccant of the purification device 300 is identical to the one described in the first embodiment.

In the third embodiment illustrated in FIG. 6, the system for locking the purification device 300 also has the fixing bushing 42 described in the first embodiment.

The fixation of the purification device 300 formed integrally with the first interface 319a in position on the bundle 2 requires that the locking system also comprise the connecting bushing 44 described in the first embodiment. In the embodiment illustrated in FIG. 6, the two pierced holes in the recesses 46 of the connecting bushing 44 open onto the second slot 325 of the flange 308. Each pierced hole allows through a part of the spring clip 48 of the locking system, which is accommodated in the second slot 325.

Following the crimping of the connecting bushing 44 to the fixing bushing 42, the purification device 300 is introduced into the first distribution chamber 15 through the first upper opening 36 of the first distribution chamber 15. The bottom 305 of the container 303 then comes into contact with the indentation 41. The flange 308 of the purification device 300 is located outside the first distribution chamber 15 and inside the connecting bushing 44. Then, the spring clip 48 is positioned in the recesses 46, and each pierced hole is then passed through by a part of the spring clip 48 in order to be accommodated in the second slot 325. The spring clip 48 is deformed elastically, thereby holding the purification device 300, in one piece with the first interface 319a, in position in the heat exchanger 1 by virtue of the connecting bushing 44. The sealing between the bundle 2 and the purification device 300 is ensured by the O-ring 326 accommodated in the first slot 324, the compression of which is brought about by the positioning of the spring clip 48. The sealing between the connecting bushing 44 and the first interface 319a is ensured by the O-ring 326 accommodated in the first slot 324, the compression of which between the flange 308 and the connecting bushing 44 is brought about by the spring clip 48, which therefore makes it possible hold the purification device 300, formed integrally with the first interface 319a, on the bundle 2 of the heat exchanger 1. In other words, the sealed connection between the bundle 2 and the purification device 300 is brought about by the compression of the O-ring 326 effected by the positioning of the spring clip 48 in the second slot 325.

In order to change the purification device 300 of the heat exchanger 1 of this third embodiment, it is first of all necessary to remove the spring clip 48. After removing the spring clip 48, the purification device 300 is disconnected from the connecting bushing 44 and therefore from the bundle 2 of plates 3. The heat exchanger 1 can then be purged of the first fluid. Next, the purification device 300 can be withdrawn by orienting the first upper orifice 36 of the first distribution chamber 15. Once the purification device 300 has been withdrawn, the first distribution chamber 15 is empty and ready to house another purification device 300.

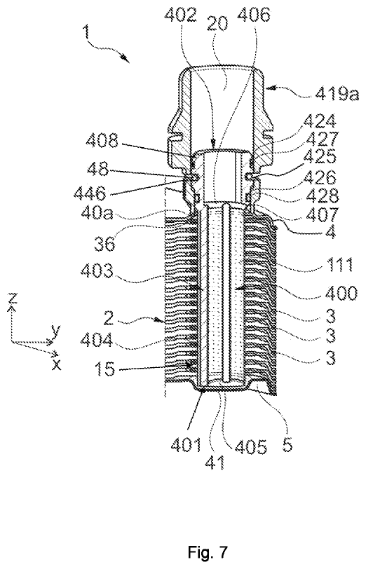

FIG. 7 illustrates a fourth embodiment of the purification device 400 according the invention. This fourth embodiment aims in particular to reduce the number of parts to be assembled in order to place the purification device 400 in the heat exchanger 1, by eliminating the fixing bushing 42 and the connecting bushing 44 of the first embodiment. The fourth embodiment illustrated in FIG. 7 is identical to the first embodiment apart from the purification device 400 and the first interface 419a. For the elements that are identical, reference can be made to the description of FIGS. 1 to 4, which are described above.

As illustrated in FIG. 7, the heat exchanger 1 comprises a purification device 400 disposed in the first distribution chamber 15. At least a part of the purification device 400 comprises a shape substantially complementary to a shape of the first distribution chamber 15 in which it is partially arranged. Since the first distribution chamber 15 is a straight cylinder with a circular base, the purification device 400 therefore has a part in the form of a straight cylinder with a circular base.

The purification device 400 extends along a direction of extension substantially parallel to the vertical axis Z. The purification device 400 has a first vertical end 401 and a second vertical end 402 at the opposite end from the first vertical end 401 along the vertical axis Z.

The purification device 400 comprises a container 403 having a lateral wall 404. The lateral wall 404 has a shape with a circular section and is symmetric overall about the vertical axis Z. Moreover, the lateral wall 404 has three windows. The container 403 delimits the cylindrical perimeter of the purification device 400. The container 403 is closed at the first vertical end 401 by a bottom 405. The lateral wall 404 and the bottom 405 are made in one piece. The bottom 405 rests in the indentation 41 of the lower end plate 5. The container 403 is therefore a perforated support defining a perimeter of the purification device 400 and a compartment of the purification device 400.

The container 403 has an opening 406 at the second vertical end 402. The opening 406 is delimited by an edge 407. In the context of the example illustrated in FIG. 7, the container 403 has a collar 408 that extends substantially vertically along the vertical axis Z from the edge 407 away from the container 403. The collar 408 has a diameter larger than a diameter of the container 403 as seen in the horizontal plane, as defined above. The collar 408 is formed integrally with the container 403. The collar 408 is situated outside the bundle 2 of plates 3 when the purification device 400 is in position in the heat exchanger 1.

The collar 408 cooperates with the first interface 419a in order that the flow of the first fluid from the loop passes into the purification device 400 before entering the first circulation tubes. Thus, the collar 408 is accommodated inside the passage 20 of the first interface 419a.

The collar 408 of the purification device 400 comprises a system for locking the purification device 400 to the first interface 419a. The locking system has a first slot 424 that houses a first O-ring 427, which is a sealing member. The first O-ring 427 may comprise for example an elastomer. The first slot 424 extends circumferentially around a radial end of the collar 408.

The system for locking the collar 408 comprises a second slot 425 in the vicinity of the first slot 424. The second slot 425 is arranged circumferentially on the outside of the collar 408. The second slot 425 houses a spring clip 48.

The system for locking the collar 408 comprises a third slot 426 in the vicinity of the second slot 425. The third slot 426 is arranged circumferentially around a radial end of the collar 408. The second slot 425 is disposed between the first slot 424 and the third slot 426 along the vertical axis Z. The third slot 426 accommodates a second O-ring 428, which is a sealing member. The second O-ring 428 may comprise an elastomer.

The purification device 400 also comprises a filter. The filter has a filtering surface 111, which is identical to the filtering surface 111 of the first embodiment.

A method for manufacturing the purification device 400 involves disposing the filtering surface 111 in a mold and then injecting material to overmold the container 403 on the filtering surface 111 with the collar 408. The material may in particular be aluminum or an aluminum alloy.

To eliminate the water mixed with the first fluid, the purification device 400 comprises at least one desiccant accommodated in the container 403. The desiccant of the purification device 400 is identical to the one described in the first embodiment.

The first interface 419a is in the overall form of a sleeve having a passage 20. A diameter of the passage 20 is greater than a diameter of the collar 418 in the horizontal plane. The first interface 419a comprises two recesses 446 that are arranged radially on an outer wall of the sleeve. The two recesses 446 are diametrically opposite one another with respect to the vertical axis Z. These recesses 446 serve to accommodate the spring clip 48.

The recesses 446 have two pierced holes that open onto the second slot 425 of the first interface 419a. The two pierced holes are diametrically opposite one another. Each pierced hole allows through a part of the spring clip 48, which is accommodated in the second slot 425 of the first interface 419a.

The fixation of the purification device 400 in position in the first distribution chamber 15 of the heat exchanger 1 requires, in a first step, the brazing of the first interface 419a to the upper end plate 4 such that the passage 20 is in communication with the first upper mouth 40a. In a second step, the purification device 400 is introduced into the first distribution chamber 15 by passing it through the passage 20. A third step consists in inserting the spring clip 48 into the two recesses 446 in the first interface 419a, each pierced hole then being passed through by a part of the spring clip 48 in order to be accommodated in the second slot 425. The spring clip 48 is deformed elastically, thereby holding the purification device 400 with the first interface 419a in position in the heat exchanger 1. The sealing between the bundle 2 and the purification device 400 is ensured by the first O-ring 427 and the second O-ring 428, which are accommodated respectively in the first slot 424 and the third slot 426. Their compression between the collar 408 and the passage 20 is brought about by the positioning of the spring clip 48 in the second slot 425.

In order to change the purification device 400 of the heat exchanger 1 of this fourth embodiment, it is first of all necessary to remove the spring clip 48. After removing the spring clip 48, the purification device 400 is disconnected from the first interface 419a and therefore from the bundle 2 of plates 3. The heat exchanger 1 can then be purged of the first fluid. Next, the purification device 400 can be withdrawn from the first distribution chamber 15. Once the purification device 400 has been withdrawn, the first distribution chamber 15 is empty and ready to house another purification device 400.

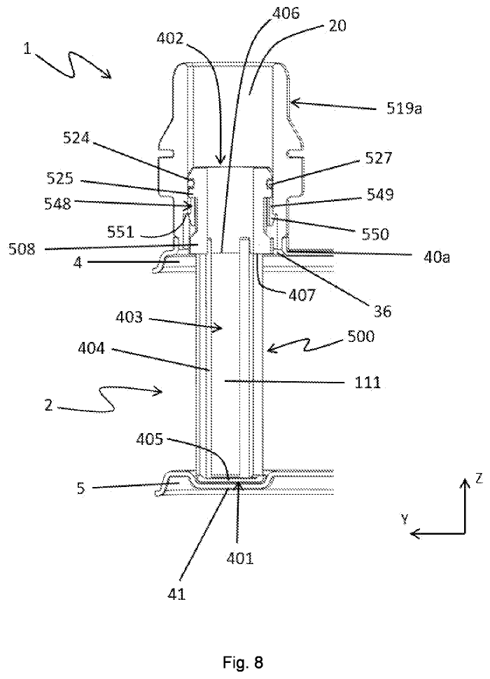

FIG. 8 illustrates a fifth embodiment of the purification device according the invention. This fifth embodiment is an alternative solution to the spring clip 48 of the fourth embodiment. The fifth embodiment illustrated in FIG. 8 is identical to the fourth embodiment apart from the collar 408 and the first interface 419a of the fourth embodiment. For greater clarity, the plates 3 have been omitted from FIG. 8. For the elements that are identical, reference can be made to the description of FIGS. 1 to 4 and to FIG. 7, which are described above.

As illustrated in FIG. 8, the collar 508 of the purification device 500 of the heat exchanger 1 is situated outside the bundle 2 of plates when the purification device 500 is in position in the heat exchanger 1.

The collar 508 cooperates with the first interface 519a in order that the flow of the first fluid from the loop passes into the purification device 500 before entering the first circulation tubes.

The collar 508 comprises a system for locking the purification device 500 to the first interface 519a. The locking system comprises a slot 524 which houses an O-ring 527, which is a sealing member. The O-ring 527 may comprise for example an elastomer. The slot 524 extends circumferentially around a radial end of the collar 508.

The system for locking the collar 508 of the purification device 500 comprises holding members 548 in the vicinity of the slot 524. Each holding member 548 is arranged from a lower border 525 of the slot. Each holding member 548 is in the form of a blade 549 which extends from the lower border 525 toward the bundle 2 along the vertical axis Z. A free end of the blade 549 comprises a protuberance 550. The protuberance 550 extends from the free end of the blade away from the collar 508. The holding member 548 immobilize the purification device 500 in the heat exchanger 1 when the purification device 500 is in position in the heat exchanger 1. There are three holding members 548. They are distributed uniformly around the lower border 525.

As shown in FIG. 8, the first interface 519a is in the overall form of a sleeve having a passage 20. The sleeve has the overall shape of a straight cylinder with a circular base along the vertical axis Z. The passage 20 comprises a cross-sectional narrowing along the vertical axis Z. Thus, a cross section of a portion of the passage 20 close to the bundle 2 is larger than a cross section of another portion of the passage 20 at a distance from the bundle 2. This cross-sectional narrowing creates a shoulder 551.

The fixation of the purification device 500 in position in the first distribution chamber 15 of the heat exchanger 1 requires, in a first step, the brazing of the first interface 519a to the upper end plate 4 such that the passage 20 is in communication with the first upper mouth 40a and therefore the first distribution chamber 15. In a second step, the purification device 500 is introduced into the first distribution chamber 15 by passing it through the passage 20 until the fixing members 548 cooperate with the shoulder 551. In other words, the fixing member 548 are snap-fastened after the protuberances 550 have passed over the shoulder 551 during the insertion of the purification device 500. The sealing between the bundle 2 and the purification device 500 is ensured by the O-ring 527, which is compressed between the collar 508 and the passage 20.

In order to change the purification device 500 of the heat exchanger 1 of this fifth embodiment, the snap-fastening of the purification device 500 is reversed, and the purification device 500 can then be withdrawn from the first distribution chamber 15. Once the purification device 500 has been withdrawn, the first distribution chamber 15 is empty and ready to house another purification device 500.

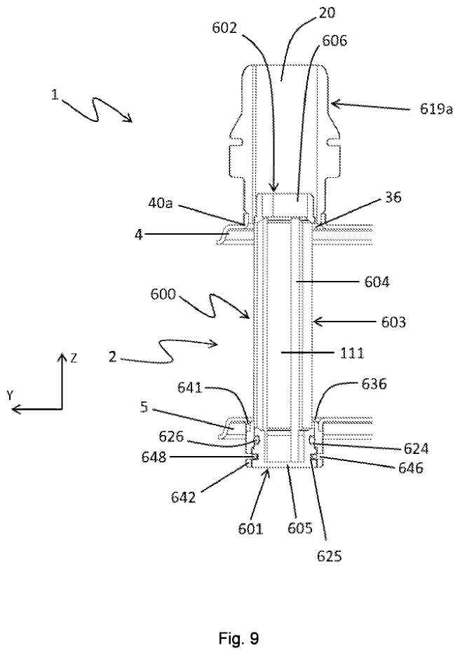

FIG. 9 illustrates a sixth embodiment of the purification device according the invention. This sixth embodiment illustrates the insertion of the purification device 600 away from the first upper orifice 36 along the vertical axis Z. The sixth embodiment illustrated in FIG. 9 is identical to the first embodiment described apart from the indentation 41 of the first embodiment, the first interface 19a of the first embodiment and the purification device 100 of the first embodiment. For the elements that are identical, reference can be made to the description of FIGS. 1 to 4, which are described above. For greater clarity in FIG. 9, the plates of the bundle 2 are not shown.

With reference to FIG. 9, the first interface 619a is in the overall form of a sleeve having a passage 20. The sleeve has the overall shape of a straight cylinder with a circular base. The passage 20 is straight.

The first interface 619a is brazed to the upper end plate 4 such that the passage 20 is in communication with the first upper mouth 40a and therefore with the first upper orifice 36 of the first distribution chamber 15. The first upper mouth 40a is therefore an opening for admitting the first fluid into the first distribution chamber 15 of the bundle 2 of the heat exchanger 1.

As shown in FIG. 9, the lower end plate 5 comprises a first lower mouth 641 disposed in line with the holes 35a. The first lower mouth 641 delimits a first lower orifice 636 of the first distribution chamber 15.

As illustrated in FIG. 9, the heat exchanger 1 comprises a purification device 600 disposed in the first distribution chamber 15. At least a part of the purification device 600 comprises a shape substantially complementary to a shape of the first distribution chamber 15 in which it is partially arranged. Since the first distribution chamber 15 is a straight cylinder with a circular base, the purification device 600 therefore has a part in the form of a straight cylinder with a circular base. The purification device 600 extends along a direction of extension substantially parallel to the vertical axis Z. The purification device 600 has a first vertical end 601 and a second vertical end 602 at the opposite end from the first vertical end 601 along the vertical axis Z.

The purification device 600 comprises a container 603 having a lateral wall 604. The lateral wall 604 has a shape with a circular section and is symmetric overall about the vertical axis Z. Moreover, the lateral wall 604 has three windows. The container 603 delimits the cylindrical perimeter of the purification device 600. The container 603 is closed at the first vertical end 601 by a bottom 605. The purification device 600 therefore has an end cap in the form of the bottom 605 at an opposite end from an intake opening for the fluid. The lateral wall 604 and the bottom 605 are made in one piece. The container 603 is therefore a perforated support defining a perimeter of the purification device 600 and a compartment of the purification device 600.

The second vertical end 602 is partially accommodated in the first interface 619a, more specifically in the passage 20. The container 603 has an opening 606 at the second vertical end 602. Thus, the first fluid entering the passage 20 of the first interface 619a is filtered before passing into the first circulation path 6.

The bottom 605 comprises a device for fixing the purification device 600 in the region of the first lower mouth 641. The fixing device comprises a first slot 624 which accommodates an O-ring 626, which is a sealing member. The O-ring 626 may comprise for example an elastomer. The first slot 624 extends circumferentially around a radial end of the bottom 605 with respect to the vertical axis Z.

The fixing device furthermore comprises a second slot 625 which at least partially houses a spring clip 648. The second slot 625 is in the vicinity of the first slot 624. The first slot 624 is arranged between the bundle 2 and the second slot 625 along the vertical axis Z.

The fixing device also comprises a spring clip 648, for example a circlip. The spring clip 648 cooperates with the first slot 625.

The purification device 600 also comprises a filter which has a filtering surface 111 identical to the filtering surface 111 described in the first embodiment.

To eliminate the water mixed with the first fluid, the purification device 600 comprises at least one desiccant accommodated in the container 603. The desiccant of the purification device 600 is identical to the one described in the first embodiment.

A method for manufacturing the purification device 600 involves disposing the filtering surface 111 in a mold and then injecting material to overmold the container 603 on the filtering surface 111. The material may in particular be aluminum or an aluminum alloy.

In the sixth embodiment illustrated in FIG. 9, the fixation of the purification device 600 in position in the heat exchanger 1 requires a holding bushing 642. The holding bushing 642 is in the overall shape of a cylinder with a circular base. The holding bushing 642 comprises two recesses 646 arranged on a part of the circumference, that is to say on the outer wall of the holding bushing 642. The two recesses 646 are diametrically opposite one another with respect to the vertical axis Z. These recesses 646 serve to accommodate the spring clip 648.

The recesses 646 have two pierced holes that open onto the first slot 624 of the bottom 605. The two pierced holes are diametrically opposite one another. Each pierced hole allows through a part of the spring clip 648, which is accommodated in the second slot 625 of the bottom 605.

The holding bushing 642 is brazed to the first lower mouth 641 in order to fix it to the lower end plate 5 and around the first lower orifice 636 of the first distribution chamber 15. The purification device 600 is introduced into the first distribution chamber 15 through the first lower opening 636 of the first distribution chamber 15. The orifice of the container 606 is accommodated in the passage 20 of the first interface 619a. A bottom wall of the bottom 605 extends in the horizontal plane and is flush with the inner side of the holding bushing 642. Then, the spring clip 648 is positioned in the recesses 646, and each pierced hole is then passed through by a part of the spring clip 648 in order to be accommodated in the second slot 625 of the cover. The spring clip 648 is deformed elastically, thereby holding the purification device 600 in position at the holding bushing 642 and therefore at the bundle 2. The sealing between the bundle 2 and the purification device 600 is ensured by the O-ring 626 accommodated in the first slot 624, the compression of which between the holding bushing 642 and the bottom 605 is brought about by the positioning of the spring clip 648.

In order to change the purification device 600 of the heat exchanger 1 of this sixth embodiment, it is first of all necessary to remove the spring clip 648. After removing the spring clip 48, the purification device 600 is disconnected from the holding bushing 642 and therefore from the bundle 2. The heat exchanger 1 can then be purged of the first fluid. Next, the purification device 600 can be withdrawn through the first lower orifice 636 of the first distribution chamber 15. Once the purification device 600 has been withdrawn, the first distribution chamber 15 is empty and ready to house another purification device 600.

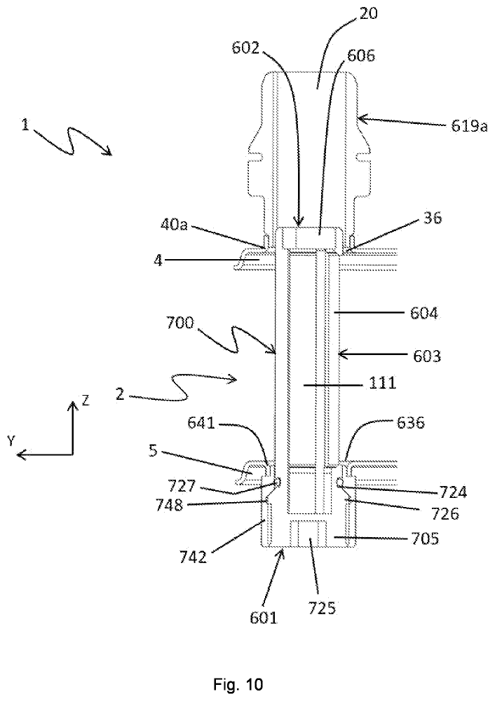

FIG. 10 illustrates a seventh embodiment of the purification device according the invention. This seventh embodiment is identical to the sixth embodiment described apart from the bottom 705 and the fixing device, and the holding bushing 742. For the elements that are identical, reference can be made to the description of FIG. 9, which is described above. The plates of the bundle 2 are not shown in FIG. 10 for greater clarity.

With reference to FIG. 10, the holding bushing 742 is in the overall shape of a hollow cylinder with a circular base. The holding bushing 742 comprises a tapped thread 743 inside the hollow cylinder. The tapped thread 743 is configured to cooperate with a screw thread 726 of the bottom 705.

The fixing device, and therefore the bottom 705, comprises a screw head 725. The screw head 725 is at the first end 601 of the purification device 700. It also comprises a screw thread 726 which extends circumferentially around a radial end of the bottom 705. The fixing device also comprises a slot 724 which accommodates an O-ring 727, which is a sealing member. The O-ring 727 may comprise for example an elastomer. The slot 724 extends circumferentially around a radial end of the bottom 705 with respect to the vertical axis Z. The slot 724 is arranged between the screw thread 726 and the bundle 2.

The holding bushing 742 is brazed to the first lower mouth 641 in order to fix it around the first lower orifice 636 of the first distribution chamber 15. The purification device 700 is introduced into the first distribution chamber 15 through the first lower opening 636 of the first distribution chamber 15. The bottom 705 is then screwed in order that the orifice of the container 606 is accommodated in the passage 20 of the first interface 619a and the purification device 700 at least partially accommodated in the first distribution chamber 15. The sealing between the bundle 2 and the purification device 700 is ensured by the O-ring 727 accommodated in the slot 724, the compression of which is brought about by the positioning of the bottom 705 in the holding bushing 742.

In order to change the purification device 700 of the heat exchanger 1 of this seventh embodiment, all that is necessary is to unscrew the bottom 705 using a tightening tool which could cooperate with the screw head 725. Once the purification device 700 has been withdrawn, the first distribution chamber 15 is empty and ready to house another purification device 700.

The heat exchanger 1 designed in this way is able to operate according to the following example, using the references of the first embodiment. This example is not limiting and can be applied to the other embodiments described.

Moreover, other modes of operation can be envisioned. Among these modes of operation, there is the possibility of designing the circuits so as to cause the fluids to circulate therein in a plurality of passes.

On the basis of the first embodiment described, which is illustrated in FIGS. 1 to 4, the first fluid enters the heat exchanger 1 through the first interface 19a. The first fluid is then filtered by the purification device 100 when it passes into the first distribution chamber 15. Then, the first fluid circulates in the first circulation path 6 toward the fourth interface 19d in a single pass. The circulation of the first fluid is disrupted by the disrupting devices 34. The first fluid is then discharged from the fourth interface 19d toward a loop thermally coupled to an electrical storage device.

The second fluid enters the heat exchanger 1 through the second interface 19b. The second fluid circulates in the second circulation path 7 via the second distribution chamber 17. The first fluid circulating in the first circulation path 6 then transfers its heat energy to the second fluid. This transfer of heat energy is manifested by cooling of the first fluid, which passes from the gaseous state into a two-phase gas-liquid state and then into a liquid state. The flow of the second fluid is disrupted by the disrupting devices 34 present in the second circulation path 7. The second fluid is subsequently discharged from the heat exchanger 1 via the third interface 19c.

The different embodiments described can be implemented for the first discharge chamber 16. For example, in addition to the first distribution chamber 15, the first discharge chamber 16 comprises in particular a second purification device according to any one of the embodiments described above. This second purification device may comprise a filter in the form of a filtering surface 111 and/or a compartment configured to accommodate a desiccant for the highly likely event of water being able to infiltrate into the loop. This may be the case in particular in hot countries with a high level of humidity.

It is also possible to place a purification device according to one of the embodiments described above in the second distribution chamber 17 and/or in the second discharge chamber 18.

Of course, the invention is not limited to the examples that have just been described, and numerous modifications may be made to these examples without departing from the scope of the invention.

What is claimed is:

1. A heat exchanger for a motor vehicle, comprising
a plurality of plates, the plates being stacked one on top of another in a stacking direction to form a bundle of plates,
at least one first plate and at least one second plate defining a first circulation path configured for circulation of a first fluid,
at least the second plate and at least one third plate defining a second circulation path configured for circulation of a second fluid,
the bundle of plates including
a first distribution chamber configured to supply the first circulation path with the first fluid, and
a second distribution chamber configured to supply the second circulation path with the second fluid,
wherein the heat exchanger includes at least one purification device accommodated in one of the distribution chambers.

2. The heat exchanger as claimed in claim 1, wherein the heat exchanger includes an interface enabling cooperation between an orifice of the distribution chamber accommodating the at least one purification device and the at least one purification device.

3. The heat exchanger as claimed in claim 2, wherein the interface is integral with at least a part of the at least one purification device.

4. The heat exchanger as claimed in claim 1, wherein the distribution chamber accommodating the at least one purification device includes a first end and a second end, the first end being open onto an external environment of the bundle along the stacking axis.

5. The heat exchanger as claimed in claim 1, wherein the bundle has a mouth at one end, the mouth being configured to admit the fluid and for manipulating the at least one purification device with respect to the heat exchanger.

6. The heat exchanger as claimed in claim 5, wherein the at least one purification device includes a locking system for attaching the at least one purification device to the interface and to the mouth of the bundle.

7. The heat exchanger as claimed in claim 6, wherein the locking system is configured to attach the interface to the mouth of the bundle.

8. The heat exchanger as claimed in claim 4, wherein the second end of the distribution chamber accommodating the at least one purification device is open onto an external environment of the bundle along the stacking axis.

9. The heat exchanger as claimed in claim 1, wherein the at least one purification device has a fluid intake opening and an end cap located at an opposite end from a fluid intake opening.

10. The heat exchanger as claimed in claim 1, wherein the bundle has a first mouth at a first end and a second mouth at a second end, the first mouth being configured to admit the fluid and the second mouth being configured for manipulating the at least one purification device with respect to the heat exchanger.

11. The heat exchanger as claimed in claim 9, wherein the bundle has a first mouth at a first end and a second mouth at a second end, the first mouth being configured to admit the fluid and the second mouth being configured for manipulating the first purification device with respect to the heat exchanger, wherein the at least one purification device includes a fixing device configured to attach the end cap to the second mouth.

12. The heat exchanger as claimed in claim 1, wherein the at least one purification device is arranged in the first distribution chamber, and wherein the bundle of plates includes a first discharge chamber configured to receive the first fluid that has passed along the first circulation path, and the heat exchanger includes a second purification device arranged in the first discharge chamber.

13. A system for cooling an electrical storage device for a vehicle, comprising:
a heat exchanger for a motor vehicle, including
a plurality of plates, the plates being stacked on top of another in a stacking direction to form a bundle of plates,
at least one first plate and at least one second plate defining a first circulation path configured for circulation of a first fluid,
at least the second plate and at least one third plate defining a second circulation path configured for circulation of a second fluid,
the bundle of plates including
a first distribution chamber configured to supply the first circulation path with the first fluid, and
a second distribution chamber configured to supply the second circulation path with the second fluid,
the heat exchanger including at least one purification device accommodated in one of the distribution chambers; and
a loop thermally coupled to the electrical storage device and in communication with the first circulation path of the heat exchanger, and a circuit in communication with the second circulation path of the exchanger.

14. The heat exchanger as claimed in claim 5, wherein the at least one purification device includes a locking system for attaching the at least one purification device to the interface or to the mouth of the bundle.
